(19) United States
(12) Patent Application Publication
(10) Pub. No.: US 2021/0146818 A1
(43) Pub. Date: May 20, 2021

(54) Methods of conducting a wholesale transmission repair business using a mobile transmission rebuild workshop

(71) Applicant: Mikhail Yakovlev, Orlando, FL (US)

(72) Inventor: Mikhail Yakovlev, Orlando, FL (US)

(21) Appl. No.: 17/072,937

(22) Filed: Oct. 16, 2020

Related U.S. Application Data
(60) Provisional application No. 62/923,473, filed on Oct. 18, 2019.

(51) Int. Cl. B60P 3/025

(52) U.S. Cl. CPC B60P 3/025; B60P 1/54

(57) ABSTRACT

The goal of the present invention is to provide franchisees with the mobility of transmission repair services, as well as the mobility of transmission dynamometer/stand testing services, along with specialized, equipped mobile repair facilities, based on existing and future prototypes, and procedures to perform the most economical and, at the same time, high quality and cost-effective wholesale and retail transmission repair business, as shown below.

### CROSS-REFERENCE TO RELATED APPLICATIONS

I hereby claim benefit under Title 35, United States Code, Section 120 of U.S. patent application Ser. No. 62/923,473 filed Oct. 18, 2019 (hereinafter “Prior Application”). This application is a continuation of the Prior Application. The Prior Application is currently pending. The Prior Application is hereby incorporated by reference into this application.

### BACKGROUND OF THE INVENTION

### a. Field of the Invention

The present invention relates to the field of mobile automotive repair operations and facilities. More specifically, it improves on transmission repair operations and facilities to repair automobiles, trucks and other motorized equipment.

In recent years automatic transmission repair has become increasingly complex. In order to comply with higher standards on fuel economy automobile and specialized transmission manufacturers around the globe develop transmissions with more gear ratios which in turn requires more complex gearsets and even more complex control systems. The cost of skilled labor has increased to the extent that some degree of specialization permitted by mass production techniques on behalf of transmission re-manufacturers has been required in order to keep transmission rebuild costs somewhat reasonable. At the same time customer convenience has encouraged development of a mobile undercar auto repair workshops, which are limited in the type of equipment, extent of inventory and skilled labor available to them for transmission rebuild purposes. These changes have prompted the emergence of present invention of a specialty workshop which provides mobile transmission rebuild service to entities who have auto repair facilities and general auto mechanics capable of transmission removal and re-installation (R&R) service but lack highly specialized transmission rebuild technicians and necessary equipment at their disposal.

The present invention discloses wholesale methods of conducting mobile transmission repair business along with mobile transmission repair workshop for a purpose of rebuilding and dyno (stand) testing rebuilt transmissions while hired or otherwise contracted by the above stated entities for transmission rebuild services in ATVs, UTVs, automobiles, light pickup trucks, middle and heavy duty trucks, as well as the equipment used in construction, farm, warehouse, oil production industries, and the like, etc. If operating company is willing to perform mobile transmission R&R service, then present invention may be useful for mobile retail transmission repair operations as well.

### b. Description of the Related Art

Any discussion of the prior art throughout the specification should in no way be considered as an admission that such prior art is widely known or forms part of common general knowledge in the field.

There has been disclosed heretofore number of configurations of a cargo space in single and combination motor vehicles of a van and flatbed types for such mobile purposes as engine diagnostic and general auto repair described in the U.S. Pat. No. 3,697,123, issued to Gygrynuk on Oct. 10, 1972; raising vehicles for an undercar service described in the patents and patent applications: U.S. Pat. No. 3,207,264, issued to Melvin on Sep. 21, 1965, U.S. Pat. No. 3,308,845, issued to Bellas et al. on Mar. 14, 1967, U.S. Pat. No. 4,981,318, issued to Doane et al. on Jan. 1, 1991, U.S. Pat. No. 5,833,294, issued to Williams et al. on Nov. 10, 1998, U.S. Pat. No. 6,102,370, issued to Johnston on Aug. 15, 2000, U.S. Pat. No. 6,173,941 B1, issued to Johnston on Jan. 16, 2001, U.S. Pat. Application Publication No. US 2014/0119864 A1, Inventor Kiragu, Pub. Date May 1, 2014, U.S. Pat. No. 9,975,749 B2, issued to Roberson et al. on May 22, 2018, U.S. Pat. Application Publication No. US 2019/0054849 A1, Inventor Yan, Pub. Date Feb. 21, 2019; roadway emergency assistance described in the U.S. Pat. No. 3,257,031, issued to Dietz on Jun. 21, 1966; automotive fluids and tires change described in U.S. Pat. No. 5,349,980, issued to Spiegel on Sep. 27, 1994 and in U.S. Pat. No. 8,955,897 B1, issued to Miller et al. on Feb. 17, 2015, accordingly; muffler repair described in U.S. Pat. No. 3,693,818, issued to Teagarden on Sep. 26, 1972 and in U.S. Pat. No. 3,844,158, issued to Mercer on Oct. 29, 1974; radiator repair described in U.S. Pat. No. 4,688,308, issued to Alvarez on Aug. 25, 1987; detailing described in U.S. Pat. No. 7,938,448 B2, issued to Schatz et al. on May 10, 2011; war time workshops described in U.S. Pat. No. 2,358,446, issued to Couse on Sep. 19, 1944 and in U.S. Pat. No. 2,365,940, issued to Couse on Dec. 26, 1944. The prior art also contains disclosures of various removable truck decks for a roll-off type vehicle, as well as modular bodies and mission modules attached to a single commercial and military vehicles for such purposes as flat, cube, dump, welding, washroom, office, storage, pontoon, decks described in the U.S. Pat. Application Publication No. US 2007/0222259 A1, Inventor Oliver, Pub. Date Sep. 27, 2015; tank, van, flatbed, tipper flatbed, modular bodies described in U.S. Pat. Application Publication No. US 2015/0375668 A1, Inventor Millet, Pub. Date Dec. 31, 2007; several mission specific modules described in U.S. Pat. No. 9,283,882 B1, issued to Langner et al. on Mar. 15, 2016, accordingly, which increases the usefulness of the vehicles. The prior art methods of mobile repairs include a method of conducting an electronic repair business employing a mobile laboratory described in the U.S. Pat. No. 7,290,817 B1, issued to Delasse on Nov. 6, 2007 and a vehicle maintenance method using mobile vehicle maintenance station described in U.S. Pat. Application Publication No. US 2019/0054849 A1, Inventor Yan, Pub. Date Feb. 21, 2019.

There has not been provided heretofore methods of conducting a mobile transmission repair business nor a workshop for rebuilding and dyno/stand testing rebuilt transmissions at various locations employing permanent or removable structures with compartments or retractable module with said structures in cargo space of preexisting single or combination motor vehicles licensed to operate on public roads, as relates to the present invention.

Notwithstanding the fact that some degree of specialization permitted by mass production techniques on behalf of transmission re-manufacturers has been achieved in order to keep transmission rebuild costs somewhat reasonable, nevertheless, such unnecessary expenses as a shipping of transmission core to re-manufacturer and rebuilt transmission to the customer could not be avoided due to transmissions being re-manufactured out of town or, in most cases, out of state.

### BRIEF SUMMARY OF THE INVENTION

The mobility of transmission repair workshop of a wholesale and retail mobile transmission repair business of the present invention provides number of advantages over stationary businesses such as common transmission repair shops and transmission re-manufacturers. The present invention overcomes problems associated with prior art by providing customers with convenience of transmission rebuild services being conducted at their parking lot, inside service vehicle or service module. Due to local repair operations, the present invention also provides customers with lower cost of transmission rebuild services, because there is no shipping cost associated with sending transmission core out and/or rebuilt transmission shipping cost involved. The mobile transmission repair operating company also gains convenience, peace of mind and significant savings from present invention's mobile verification of rebuilt transmission proper operation—mobile testing on transmission dynamometer (also known as transmission test stand with simulated automotive load conditions), prior to returning rebuilt transmissions to customers for installation in wholesale or re-installing transmissions on customers' vehicles in retail service.

Although whole mobile transmission repair workshop of this invention would normally be situated inside of a motor vehicle's or trailer's cargo area, such variations as a workshop's transmission dynamometer situated in separate powered or unpowered vehicle or a whole workshop situated in a retractable self-contained unit (module), that is handled by a vehicle with loading/unloading means, will provide additional advantages and significant savings during wholesale operations at present time and at the near future, as shown in Detailed Description of the Invention.

### BRIEF DESCRIPTION OF THE DRAWINGS

FIG. 1 is a plan view of a first variation of the present invention showing components of a first part of mobile transmission rebuild workshop situated in a van body's prototype, which is ready for its operational use.

FIG. 2 is a plan view of a first variation of the present invention illustrating components of a second part of mobile transmission rebuild workshop situated in cargo space of an unpowered vehicle (trailer).

FIG. 3 is a plan view of a second variation of the present invention illustrating components of a whole mobile transmission rebuild workshop situated in a retractable self-contained unit (module).

FIG. 4 is a side perspective view of a truck with folded self-loading crane illustrating variation of a loading/unloading means for a whole mobile transmission rebuild workshop situated in a retractable self-contained unit (module).

### DETAILED DESCRIPTION OF THE INVENTION

Purpose and overview: The purpose of the present invention is to provide franchisees (customers) with the mobility of transmission repair services, as well as the mobility of transmission dynamometer/stand testing services, along with specialized, equipped mobile repair facilities, based on existing and future prototypes, and procedures to perform the most economical and, at the same time, high quality and cost-effective wholesale and retail transmission repair business.

Overall structure of first variation of mobile transmission rebuild workshop, consisting of two parts.

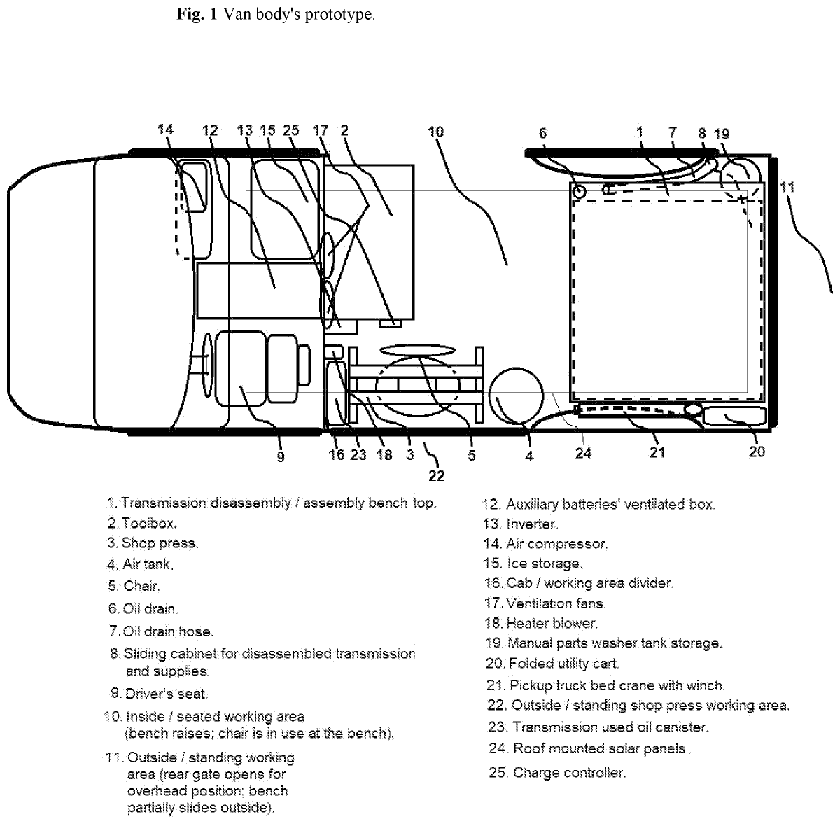

Part 1: In FIG. 1, the first variation's part 1 of the present invention's mobile transmission rebuild workshop, situated in van's prototype, has a partially sliding or raisable transmission disassembly/assembly bench top 1 with directional and adjustable inclination, main frame of which securely affixed to van prototype's floor; with an internal oil drain 6; attachable oil drain hose 7, which is routed throughout van prototype's floor; outside end of the oil drain hose 7 with cap, which affixed to the inside of van prototype's rear bumper (not shown); sliding cabinet for disassembled transmission and supplies 8; replaceable manual parts washer tank 19; outside/standing working area 11, access to which is provided by van prototype's rear overhead gate, while in open position; outside/standing shop press working area 22, access to which is provided by van prototype's rear left sliding door while in open position; inside/seated working area 10, access to which is provided by van prototype's rear right sliding door; chair 5; folded utility cart 20; pickup truck bed crane with winch 21; toolbox 2; air tank 4, which air lines' ends (not shown) are connected to outside/standing working area 11 and 22 and inside/seated working area 10; shop press 3; transmission used oil canister 23; cab/working area divider 16; driver's seat 9; auxiliary batteries' ventilated box 12, which wired to van prototype's battery (not shown) and to inverter 13; air compressor 14, which is wired to inverter 13 and which air lines (not shown) are connected to air tank 4; heater blower 18, which all (21, 2, 4, 3, 18, 16, 9, 12, 14) securely affixed to van prototype's floor; ice storage 15; ventilation fans 17, which securely affixed to cab/working area divider 16; inverter 13, which securely affixed to toolbox 2 and wired to auxiliary batteries' ventilated box 12; roof mounted solar panels 24, which wired to charge controller 25; charge controller 25, which wired to auxiliary batteries' ventilated box 12.

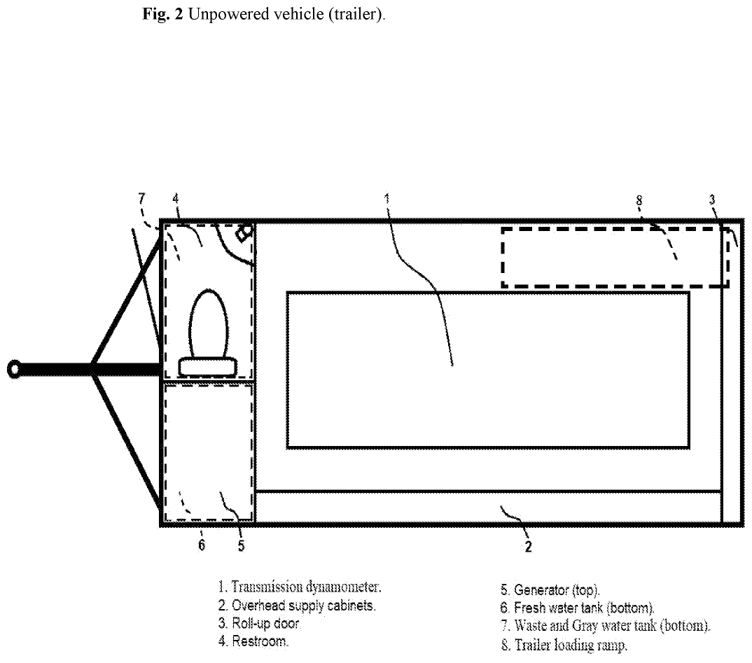

Part 2: In FIG. 2, the first variation's part 2 of the present invention's mobile transmission rebuild workshop, situated in cargo space of an unpowered vehicle (trailer), has a transmission dynamometer 1, which is securely affixed to an unpowered vehicle's frame and wired to generator 5; overhead supply cabinets 2, which securely affixed to unpowered vehicle's side wall; roll-up door 3; restroom 4, which piping is connected to waste and gray water tank 7 and fresh water tank 6; generator 5, which is located at the top of fresh water tank 6 and which exhaust is routed throughout unpowered vehicle's floor; fresh water tank 6, which is securely affixed to an unpowered vehicle's frame; waste and gray water tank 7, which is securely affixed to unpowered vehicle's frame; trailer loading ramp 8, which is inserted and secured in unpowered vehicle's frame.

Mobility of transmission repair and testing services utilizing first variation and description of methods to conduct mobile wholesale transmission rebuild business. The following description applies to FIG. 1 and FIG. 2, shown in the accompanying drawings. Upon arrival at a service call location, the highly specialized professional transmission rebuilder takes necessary paperwork and folded utility cart 20; receives authorizing repair signature and not functioning transmission from a customer's contact person; brings transmission and paperwork back to the service vehicle by means of unfolded utility cart 20; with service vehicle's rear gate open, unlocks, slides outside and lock transmission disassembly/assembly bench top 1; unplugs oil drain 6; connects attachable oil drain hose 7 to oil drain 6; disconnects outside end of oil drain hose 7 from the inside of service vehicle rear bumper; takes transmission used oil canister 23 and places it next to rear right service vehicle's wheel; inserts outside end of oil drain hose 7 into the transmission used oil canister 23; using pickup truck bed crane with winch 21, lifts transmission off utility cart onto transmission disassembly/assembly bench top 1; folds and puts back folded utility cart 20; turns on inverter 13; turns on air compressor 14; from toolbox 2 takes transmission disassembly hand tools along with air tools; goes into outside/standing working area 11; removes and drains torque converter, if present; drains oil from transmission onto transmission disassembly/assembly bench top 1, which flows toward oil drain 6 due to adjustable inclination of the bench; removes valve body (transmission's control system) from transmission, puts it in plastic bag and places it in sliding cabinet for disassembled transmission and supplies 8; checks end-plays, clearances and preloads while disassembles transmission; removes and inspects transmission internal components for damage and excessive wear, when needed goes into outside/standing shop press working area 22 to use shop press 3; communicates with customer's contact person or operating company on damages discovered and adjusts price accordingly, if needed; orders soft parts along with torque converter and hard parts if needed; places tools back into toolbox 2; cleans transmission disassembly/assembly bench top 1 from oil that is left on the bench; disconnects attachable oil drain hose 7 from oil drain 6; takes manual parts washer tank from its storage place 19; attaches cleaning hose/brush assembly to manual parts washer's pump located in the tank (not shown); fills manual parts washer's tank 19 with solvent; places manual parts washer tank 19 underneath oil drain 6; plugs manual parts washer pump's electric cord into inverter's 13 receptacle; using manual parts washer tank's 19 cleaning accessories washes undamaged transmission parts and transmission case; stores washed transmission parts in sliding cabinet for disassembled transmission and supplies 8; cleans transmission disassembly/assembly bench top 1 from dirty solvent that is left on the bench; if desired, continues working while standing in outside/standing working area 11, or, unlocks, slides inside, raises and locks transmission disassembly/assembly bench top 1 for seated working position; removes valve body and canister with clean solvent from sliding cabinet for disassembled transmission and supplies 8 and places it on transmission disassembly/assembly bench top 1; moves chair 5 from its storage place underneath shop press 3 into inside/seated working area 10; starts service vehicle's engine and turns a/c or heater on (auxiliary batteries' operated heater blower 18 provided), or turns on auxiliary batteries' operated ventilation fan(s) 17 and keeps service vehicle's rear gate in overhead open position; goes into inside/seated working area 10; removes valve body from plastic bag; using clean solvent cleans valve body; takes necessary tools to rebuild valve body from toolbox 2; rebuilds valve body and, if needed, communicates with customer's contact person or operating company on damages discovered and adjusts price accordingly; if needed, orders hard valve body parts and/or service kits; places valve body tools back into toolbox 2; cleans transmission disassembly/assembly bench top 1 from dirty solvent that is left on the bench; plugs oil drain 6; disconnects washing accessories from manual parts washer tank and returns it back into its storage place 19; upon replacement parts arrival or otherwise, places hard to install transmission hard parts and/or soft parts into ice storage 15; assembles valve body and puts it in a new plastic bag; places chair 5 back in its storage place underneath shop press 3; places plastic bag with rebuilt valve body in sliding cabinet for disassembled transmission and supplies 8; unlocks, lowers, slides outside and locks transmission disassembly/assembly bench top 1; takes necessary tools to assemble transmission from toolbox 2 and goes into outside/standing working area 11; removes washed parts from sliding cabinet for disassembled transmission and supplies 8 and places it on transmission disassembly/assembly bench top 1; assembles transmission, checks end-plays and clearances, makes preload adjustments, when needed goes into outside/standing shop press working area 22 to use shop press 3, when needed removes hard to install transmission hard parts and/or soft parts from ice storage 15 for installation; reports to operating company on his readiness for rebuilt transmission dynamometer test; removes rebuilt valve body from sliding cabinet for disassembled transmission and supplies 8; removes valve body from plastic bag and installs it into transmission; closes and tightens transmission oil pan and places tools back into toolbox 2; fills, installs and secures torque converter, if present; upon arrival of a vehicle (powered, is not shown, or unpowered as shown in FIG. 2) carrying transmission dynamometer, unfolds utility cart 20 and places it on the ground; using pickup truck bed crane with winch 21 loads rebuilt transmission on utility cart 20; moves rebuilt transmission to the vehicle with transmission dynamometer; passes rebuilt transmission to dynamometer's operator/manager; goes back to clean and organize his service vehicle; upon completion of the testing, depending on the result, dynamometer's operator/manager notifies rebuilder of testing results and takes rebuilt and tested transmission back to the customer's contact person to proceed with the payment, or, takes it back to rebuilder to correct the problem he or she found; testing procedure repeats until rebuilt transmission successfully passes dynamometers' tests; upon completion of testing the dynamometer's operator/manager takes rebuilt and tested transmission to the customer's contact person to proceed with the payment; service is completed.

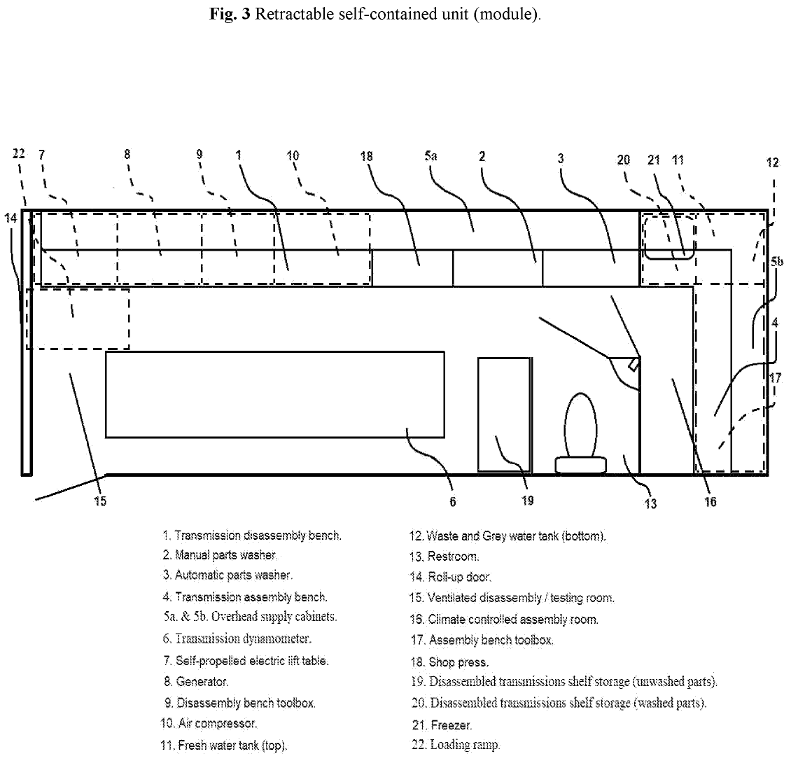

Overview of overall structure of second variation of mobile transmission rebuild workshop: In FIG. 3, the second variation of the present invention's mobile transmission rebuild workshop, situated in a retractable self-contained unit (module), has a transmission disassembly bench 1; shop press 18; manual pars washer 2; automatic parts washer 3, which is wired to generator 8; transmission assembly bench 4; assembly bench toolbox 17; waste and gray water tank 12; disassembled transmissions shelf storage (washed parts) 20; air compressor 10, which is wired to generator 8; generator 8, which exhaust is routed throughout module's floor; transmission dynamometer 6; disassembled transmissions shelf storage (unwashed parts) 19; disassembly bench toolbox 9; which all (9, 1, 18, 2, 3, 4, 17, 12, 20, 10, 8, 6, 19) securely affixed to module's floor; overhead supply cabinets 5a and 5b, which securely affixed to module's side walls; fresh water tank 11, which securely affixed to transmission assembly bench 4; freezer 21, which is wired to generator 8; self-propelled electric lift table 7, which right side wheels are secured with straps to the module's floor; roll-up door 14; loading ramp 22, which is inserted and secured in module's frame; ventilated disassembly/testing room 15; restroom 13, which piping is connected to waste and gray water tank 12 and fresh water tank 11; climate controlled assembly room 16.

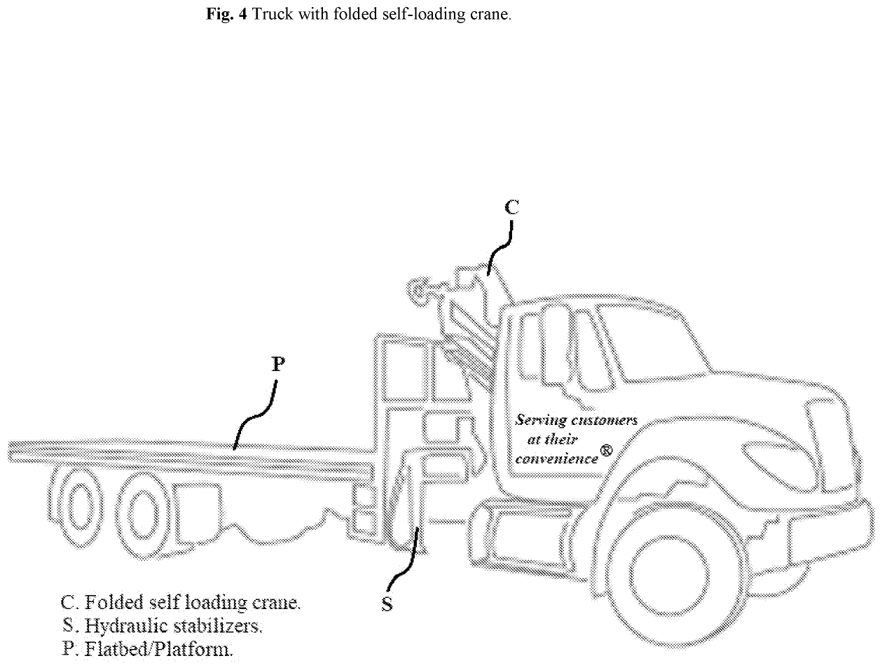

In FIG. 4 the variation of preexisting flatbed type motor vehicle, equipped with a loading/unloading means, has a folded self-loading crane C, turnable base of which is securely affixed to motor vehicle's frame; hydraulic stabilizers S, which extend outward from the sides to support motor vehicle during loading/unloading; flatbed/platform P, on which or from which the present invention's second variation whole mobile transmission rebuild workshop, situated in a retractable self-contained unit (module), can easily be loaded or unloaded.

Mobility of transmission repair and testing services utilizing second variation and description of methods to conduct mobile wholesale transmission rebuild business. The following description applies to FIG. 3, shown in the accompanying drawings. In FIG. 3 the mobile transmission repair workshop, situated in a retractable self-contained unit (module), works in much the same manner as the workshop shown in FIG. 1 and 2. The only major difference between present invention's first and second variations is the transmission dynamometer location and the duties of the rebuilder. In first variation, which has its own advantages, that were explained earlier in this section, transmission testing machine is situated in separate vehicle and operated by another technician/operations manager, whereas in second variation the dynamometer is located in the same module with rest of the equipment and operated by the rebuilder himself. The most important advantage of the present invention's second variation is its ability to be loaded and unloaded by motorized vehicle, which in turn can handle dozen or so modules.

Other variations and preferred embodiment: Among other variations of the present invention's mobile transmission rebuild workshop, incorporated or not in cargo space of preexisting single or combination powered or unpowered vehicles, such as minivan or van body, flatbed body with and/or without convertible top, hybrid utility/enclosed body, bare vehicle's frame, bare vehicle's floor, or, retractable self-contained unit (module) handled by a vehicle equipped with self-loading/unloading means, and the like, etc., the variation with vehicle of a van type body in combination with separate powered or unpowered vehicle where transmission dynamometer is situated, stands out for number of reasons. The present invention's mobile transmission rebuild workshop in van's prototype, as disclosed herein, is built to be used in said combination due to high price of transmission dynamometers at present time. Said combination makes up the present invention's preferred embodiment because savings become significant when number of van's body workshops are used in combination with lesser number of separate powered or unpowered workshops carrying transmission testing dynamometers in a wholesale operations.

Method of Manufacture. The most cost-effective means and preferred methods of manufacturing the first variation of the present invention's mobile transmission rebuild workshop, comprised of two parts, is an international production of assembly parts with domestic assembly or entire international production.

The most cost-effective means and preferred methods of manufacturing the second variation of the present invention's mobile transmission rebuild workshop, situated in a retractable self-contained unit (module), is fabrication of one model/prototype, suitable for domestic and international transmission industry trade shows, and following production, as described above. The preferred fabrication method of a module's model/prototype is in the USA, along with purchasing of necessary equipment for installation.

Methods of use. Nationwide operations of a wholesale and retail mobile transmission repair franchise, managed by team.

It is intended that all matter contained in the above descriptions or shown in the accompanying drawings shall be interpreted as illustrative and not in a limiting sense.

While the present invention has been described with respect to specific embodiments thereof, it will be understood that various changes and modifications will be suggested to one skilled in the art and it is intended that the invention encompass such changes and modifications as fall within the scope of the appended claims.

What is claimed is:

1. Mobility of transmission repair services, by means of providing said services in a mobile course of action in any place it is needed.

2. Mobility of transmission dynamometer/stand testing services, by means of providing said services in a mobile course of action in any place it is needed.

3. A vehicle created in claim 1 incorporated or not in cargo and/or passenger's space of preexisting single or combination powered or unpowered vehicle(s) licensed to operate on public roads, such as:
a minivan body vehicle;
a van body vehicle;
a flatbed body vehicle with and/or without convertible top;
a hybrid utility/enclosed body vehicle;
a bare frame vehicle;
a bare floor vehicle;
a retractable or not self-contained or not unit (module), handled by a vehicle that equipped with self-loading/unloading means;
and the like;
etc.

4. A vehicle created in claim 2 incorporated or not in cargo and/or passenger's space of preexisting single or combination powered or unpowered vehicle(s) licensed to operate on public roads, such as:
a minivan body vehicle;
a van body vehicle;
a flatbed body vehicle with and/or without convertible top;
a hybrid utility/enclosed body vehicle;
a bare frame vehicle;
a bare floor vehicle;
a retractable or not self-contained or not unit (module), handled by a vehicle that equipped with self-loading/unloading means;
and the like;
etc.

5. A mobile transmission repair workshop created in claim 3 and claim 4 further comprising methods of operations.

6. All products produced by fabrication of the mobile transmission repair workshop created in claim 3 and claim 4, or part thereof.

7. All products produced by manufacturing of the mobile transmission repair workshop created in claim 3 and claim 4, or part thereof.

8. All products produced by business operations using the mobile transmission repair workshop(s) created in claim 5 and/or of claim 6 and/or claim 7.
